(19) United States
(12) Patent Application Publication
(10) Pub. No.: US 2009/0239595 A1
(43) Pub. Date: Sep. 24, 2009

(54) MULTI-BAND BUILT-IN ANTENNA

(75) Inventors: Sang-Bong SUNG, Gumi-si (KR); Jung-Ho PARK, Hwaseong-si (KR); Jong-Kyun SHIN, Seongnam-si (KR); Jae-Ho LEE, Yongin-si (KR); Jeong-Wan PARK, Gumi-si (KR)

Correspondence Address: Jefferson IP Law, LLP, 1730 M Street, NW, Suite 807, Washington, DC, 20036, US

(73) Assignee: SAMSUNG ELECTRONICS CO. LTD., Suwon-si (KR)

(21) Appl. No.: 12/239,295

(22) Filed: Sep. 26, 2008

(30) Foreign Application Priority Data
Oct. 1, 2007 (KR) 2007-0098693

(51) Int. Cl. H04M 1/00; H01Q 1/36; H01Q 1/48; H04B 1/38

(52) U.S. Cl. 455/575.7; 343/700 MS; 343/846; 455/90.2

(57) ABSTRACT

A multi-band built-in antenna for a portable wireless terminal is provided. In the multi-band built-in antenna, a first radiation part processes signals of a first frequency band. A second radiation part, spaced apart from the first radiation part and electrically connected to the first radiation part, processes signals of a second frequency band lower than the first frequency band. And, a sub-radiator is electrically connected to the second radiation part and the sub-radiator is movable.

### PRIORITY

This application claims the benefit under 35 U.S.C. §119(a) of a Korean patent application filed in the Korean Intellectual Property Office on Oct. 1, 2007 and assigned Serial No. 2007-98693, the entire disclosure of which is hereby incorporated by reference.

### BACKGROUND OF THE INVENTION

1. Field of the Invention

The present invention relates to an antenna for a portable wireless terminal. More particularly, the present invention relates to a multi-band built-in antenna for receiving and transmitting multi-band signals for a portable wireless terminal.

2. Description of the Related Art

Currently, portable wireless terminals such as Personal Communication Systems (PCS), Global Positioning Systems (GPS), a Personal Digital Assistant (PDA), cellular phones and wireless notebook computers, are being widely used. Since their introduction, these terminals have evolved into smaller and slimmer devices based on user demand. Also, these terminals are being provided with various functions in addition to the voice communication function. Therefore, in order to continue satisfying user desires and demands, the design of the terminal is focused on a size reduction while maintaining or improving the functions as well as providing new ones.

Portable wireless terminals include an antenna for radio communication. The antenna can be classified into an external type and a built-in type. An external type antenna is installed in a portable wireless terminal in such a manner that it protrudes from the terminal body. Conversely, a built-in antenna is installed on a Printed Circuit Board (PCB, hereinafter also called a motherboard) located internally of a portable wireless terminal without any external protrusion. Further, an external antenna can be classified into a dipole antenna having a feed part and a ground part or a monopole antenna having only a feed part. The monopole antenna has a feed part electrically connected to a feed pad of a PCB. A built-in antenna can be classified in the same way. The built-in antenna is more widely used than the external antenna because of its portability and the improvements it affords to the portable terminal's external appearance.

Though the performance of the antenna is proportional to the size of the antenna, a large antenna makes the terminal bigger. Therefore, there is a need for an antenna that can improve radiation performance without increasing its size and reduce a Specific Absorption Rate (SAR).

FIG. 1 is a perspective view of a conventional dual-band built-in antenna.

Referring to FIG. 1, the antenna 100 is mounted on a mother board (i.e. PCB, not shown) and is electrically connected with the PCB.

The antenna 100 includes a radiator 120 to radiate radio signals and a carrier 110 on which the radiator 120 is affixed. The carrier 110 is manufactured by molding.

The radiator 120 includes a conductive plate 121 manufactured by sheet metal processing. The plate 121 includes a feed part 124 and a ground part 125, projected downwardly from a portion of the plate 121, coupling with the PCB. Also, the carrier 110 includes a plurality of fixing protrusions projected upwardly, and the plate 121 includes a plurality of fixing holes 123, each corresponding to a fixing protrusion. The plate 121 can be fixed to the carrier 110 by any suitable means, such as hot melt adhesion or ultrasonic welding.

The radiator 120 can be partitioned into a first radiation part 121A for processing signals of a high frequency band and a second radiation part 121B for processing signals of a low frequency band. That is, the first radiation part 121A and the second radiation part 121B process signals of different frequency bands.

Also, the first radiation part 121A and the second radiation part 121B have different radiation patterns to process signals of different frequency bands. Each radiation pattern has a width and a length. For example, a radiation pattern of the first radiation part 121A can have a greater average width than that of the second radiation part 121B. The feed part 124 provides the plate 121 with a transmission signal from the PCB. When the signal to be transmitted is received from the PCB, the first radiation part 121A processes signals of a high frequency band and the second radiation part 121B processes signals of a low frequency band.

The dual-band built-in antenna 100 only processes signals of dual-frequency bands. However, as communication technologies continue to advance, portable wireless terminals are becoming more sophisticated including the ability to operate in three or more frequency bands. Therefore, there is a need for an antenna that can accommodate and improve the processing of signals for three or more frequency bands without increasing the size of the antenna or the size of the terminal.

### SUMMARY OF THE INVENTION

An aspect of the present invention is to address at least the above-mentioned problems and/or disadvantages and to provide at least the advantages described below. Accordingly, an object of the present invention is to provide a multi-band built-in antenna for a portable wireless terminal that can process multi-band signals without increasing the size of the terminal.

Another object of the present invention is to provide a multi-band built-in antenna for a portable wireless terminal that can improve radiation performance while maintaining a slim and lightweight terminal.

A further object of the present invention is to provide a multi-band built-in antenna for a portable wireless terminal that can improve radiation performance of a high frequency band for a Digital Cellular System (DSC) and a Personal Communication System (PCS).

According to an aspect of the present invention, a multi-band built-in antenna for a portable wireless terminal is provided. The antenna includes a first radiation part for processing signals of a first frequency band, a second radiation part, spaced apart from the first radiation part and electrically connected to the first radiation part, for processing signals of a second frequency band that are lower than the first frequency band and a sub-radiator that is electrically connected to the second radiation part and is movable.

According to another aspect of the present invention, a portable wireless terminal is provided. The terminal includes an RF board having a feeding unit and grounding unit, a carrier fixed on the RF board, a first radiation part for processing signals of a first frequency band, fixed to the top surface of the carrier, a second radiation part, horizontally spaced apart from the first radiation part and electrically connected to the first radiation part, fixed to the top surface of the carrier, for processing signals of a second frequency band lower than the first frequency band, a feed part and a ground part, protruding from one end of at least one of the first radiation part and the second radiation part and electrically connected to the feeding unit and the grounding unit, respectively and a sub-radiator that is electrically connected to the second radiation part and is movable.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features, and advantages of certain exemplary embodiments of the present invention will be more apparent from the following description taken in conjunction with the accompanying drawings, in which:

FIG. 1 is a perspective view of a conventional dual-band built-in antenna;

FIG. 2 is a perspective view of a portable wireless terminal using a multi-band built-in antenna according to an exemplary embodiment of the present invention;

FIG. 3A is an exploded perspective view of a multi-band built-in antenna according to an exemplary embodiment of the present invention;

FIG. 3B is a perspective view of a multi-band built-in antenna according to an exemplary embodiment of the present invention;

FIG. 4A is a partial cross-sectional view corresponding to line A-A′ of FIG. 3B;

FIG. 4B is a partial cross-sectional view corresponding to line B-B′ of FIG. 3B;

FIG. 5 is a partial view of a portable wireless terminal according to an exemplary embodiment of the present invention;

FIG. 6 is a graph showing a Voltage Standing Wave Ratio (VSWR) of the conventional dual-band built-in antenna illustrated in FIG. 1;

FIG. 7 is a graph showing VSWR and a partial plane view of a multi-band built-in antenna according to an exemplary embodiment of the present invention, when a sub-radiator is in a position to process signals of a Digital Cellular System (DCS) frequency; and

FIG. 8 is a graph showing VSWR and a partial plane view of a multi-band built-in antenna according to an exemplary embodiment of the present invention, when a sub-radiator has moved to process signals of a Personal Communication Systems (PCS) frequency.

Throughout the drawings, it should be noted that like reference numbers are used to depict the same or similar elements, features and structures.

### DETAILED DESCRIPTION OF EXEMPLARY EMBODIMENTS

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

Though a slide type terminal is illustrated, this is merely for example and should not be considered as limiting. That is, the present invention can also be applied to other and various types of terminals, such as a flip type terminal, a folder type terminal, a bar type terminal and the like.

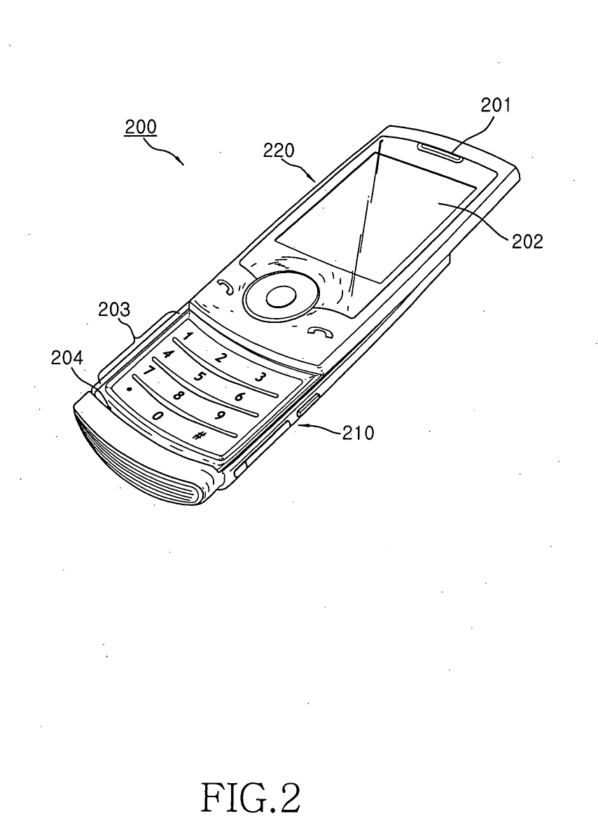

FIG. 2 is a perspective view of a portable wireless terminal using a multi-band built-in antenna according to an exemplary embodiment of the present invention.

Referring FIG. 2, a portable wireless terminal 200 includes a main body 210 and a sub-body 220 that slides on and relative to the main body 210. The main body 210 includes a keypad assembly 203 as a data input device and a microphone 204 located under the keypad assembly 203 for input of voice signals. Also, the sub-body 220 includes an earpiece 201 to output voice or other audible signals and a display 202 under the earpiece 201. In an exemplary implementation, the display 202 may be a Liquid Crystal Display (LCD) having up to millions of pixels. Also, if the LCD is provided as a touch screen, the display 202 may perform a part or all of the functions of an input unit, either supplemental or in place of keypad assembly 203.

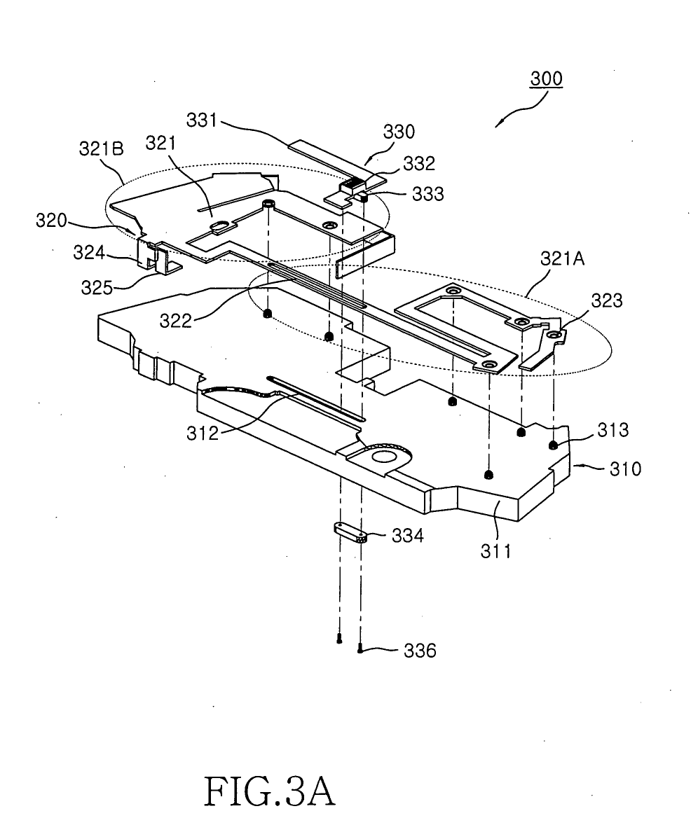

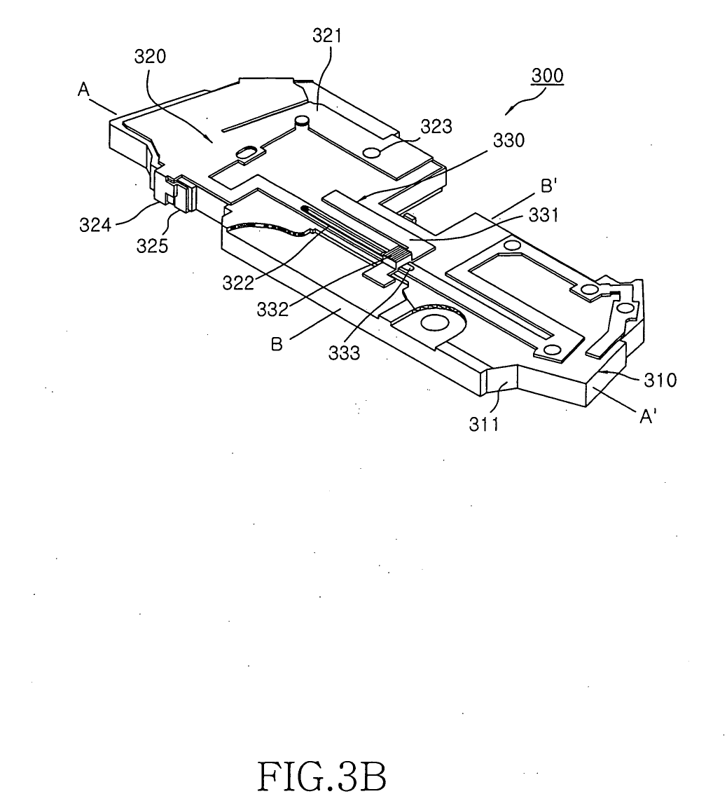

The portable wireless terminal 200 processes signals of multiple frequency bands using a multi-band built-in antenna shown, for example, in FIG. 3A according to an exemplary embodiment of the present invention.

As will be explained in more detail below, the multi-band built-in antenna of the portable wireless terminal 200 may include a sub-radiator. To process signals of the multiple frequency bands, the sub radiator may be movable.

For example, the sub-radiator may be moved to a first position for processing signals of a Global System for Mobile Telecommunication (GSM) and signals of a Digital Cellular System (DCS) and is movable to a second position for processing signals of a GSM and a Personal Communication System (PCS).

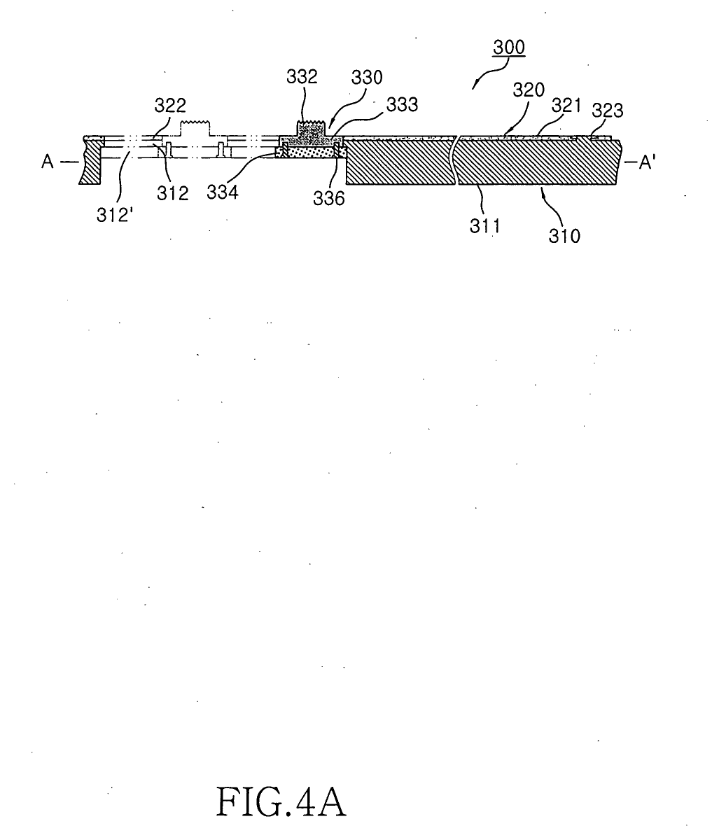

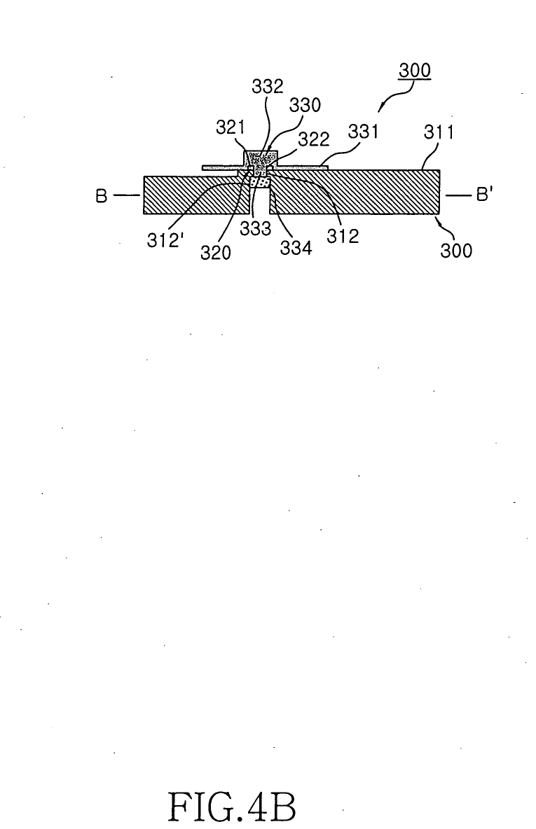

FIGS. 3A and 3B are exploded perspective views of a multi-band built-in antenna 300 according to an exemplary embodiment of the present invention and FIGS. 4A and 4B are partial cross section views respectively corresponding to lines A-A′ and B-B′ illustrated in FIG. 3B.

Referring to FIGS. 3A to 4B, the multi-band built-in antenna 300 includes a radiator 320 for transmitting and receiving radio frequency signals, a carrier 310 on which the radiator 320 is affixed and a sub-radiator 330 connected to the radiator 320. The sub-radiator 330 is movable.

The radiator 320 includes a conductive plate 321 having a radiation pattern for processing radio frequency signals. In an exemplary implementation, the conductive plate 321 is made by press processing. In addition, the conductive plate 321 is for electrically connecting the antenna 300 to a circuit board (e.g. a mother board or a Printed Circuit Board (PCB)) of a portable wireless terminal. The conductive plate 321 includes a feed part 324 and a ground part 325. The feed part 324 and the ground part 325 respectively protrude from one end of the radiator 320. Based on the configuration of the radiator 320 being affixed to the carrier 310, and the carrier 310 mounted on the PCB, the feed part 324 and the ground part 325 may be electrically connected to the PCB.

The carrier 310 also includes a body 311. In an exemplary implementation, the body 311 is made by injection molding. The body 311 of the carrier 310 includes one or more fixing protrusions 313 projecting upwardly from the top of the body 311. The plate 321 includes a plurality of fixing holes 323 corresponding to the fixing protrusions 313. Therefore, the radiator 320 can be fixed to the carrier 310 using the fixing holes 323 by any suitable fusion means, such as hot melt adhesion, ultrasonic welding and the like.

The plate 321 of the radiator 320 includes a guide slot 322. In an exemplary implementation, the guide slot 322 is formed as an elongated hole which penetrates through the plate 321. In addition, the sub-radiator 330 includes a guide protrusion 333, projected downwardly from a lower or bottom side of the sub-radiator 330. Furthermore, the body 311 of the carrier 310 includes a first sub-slot 312 corresponding to the guide protrusion 333. As best illustrated in FIGS. 3B, 4A and 4B, when the multi-band built-in antenna is assembled, the guide protrusion 333 simultaneously passes through both the guide slot 322 and through the first sub-slot 312 which are aligned with each other. Therefore, the guide protrusion 333 may be moved along a path of the guide slot 322. Also, the sub-radiator 330 is electrically connected to the radiator 320 and maintains the electrical connection while moving from one position to another.

In addition, a guide block 334 is provided to secure the configuration of the movable sub-radiator 330. More specifically, the guide block 334 is fixed to a lower side of the guide protrusion 333 by a fixing means, such as a screw 336. The guide block 334 has a larger width than the guide protrusion 333. Also, as best illustrated in FIG. 4B, the body 311 of the carrier 310 includes a second sub-slot 312′. The second sub-slot 312′ has a greater width than the first sub-slot 312 and is located under the first sub-slot 312. Accordingly, the guide block 334, fixed by fixing means 336 to the guide protrusion 333 and having a width correlating to the width of the second sub-slot 312′, is moved along a path of the second sub-slot 312′ while the guide protrusion 333 moves along a path of the guide slot 322. Furthermore, the guide block 334, having a width greater than the width of the guide protrusion 333 and greater than the width of the first sub-slot 312, prevents the guide protrusion 333 from escaping the guide slot 322. Thus, the guide block 334 secures the sub-radiator 330 as it moves in a sliding manner.

Therefore, the sub-radiator 330 is not separated upwardly from the radiator 320 because of the guide block 334 as an obstacle. Also, the sub-radiator 330 is not separated downwardly from the radiator 320 because of the plate 321 as an obstacle. Once the sub-radiator 330 is connected to the radiator 320 by the guide block 334, the sub-radiator 330 can be moved horizontally while being secured from escaping in an upward or downward direction.

The sub-radiator 330 includes a conductive sub-plate 331 having a radiation pattern, for example a right angle pattern, ‘ [symbol] ’. The sub-radiator 330 includes a handling protrusion 332 which allows for control of its movement by a user. In an exemplary implementation, the handling protrusion 332 is projected upwardly from top of the plate 331. In a further exemplary implementation, the handling protrusion 332, the guide protrusion 333 and the guide block 334 are all located on a perpendicular extension of the sub-plate 331.

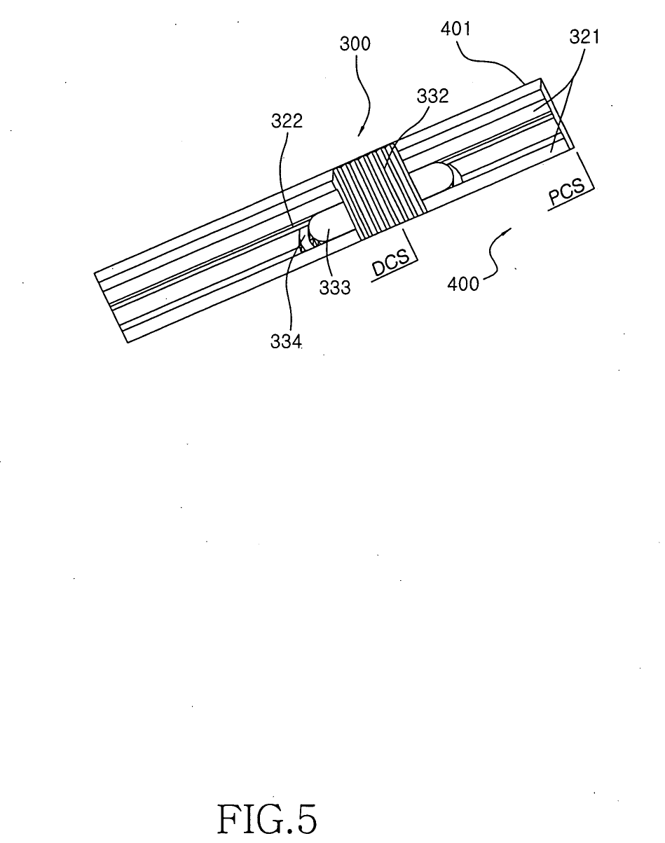

The handling protrusion 332 can be a non-conductive material. However, considering the necessary performance of the antenna, the handling protrusion 332 may also be a conductive material. As illustrated in FIG. 5 and explained in greater detail below, the handling protrusion 332 is exposed through an exterior frame 400 of the terminal. Herein, the exterior frame 400 of the terminal 200 includes a third sub-slot 401, providing a path. The handling protrusion 332 is moveable along the path provided by the third sub-slot 401.

Furthermore, as best illustrated in FIGS. 3B and 4B, the sub-plate 331 covers or surrounds the plate 321 near the guide protrusion 333. That is, the sub-plate 331 has a prominent part and a depressive part for substantially following the contour of the plate 321, especially the guide slot 322, so that, as the sub-plate 331 extends laterally relative to the plate 321, the plate 321 and the sub-plate 331 are substantially in the same plane. Accordingly, the vertical space required to mount both the plate 321 and the sub-plate 331 is substantially the same as the vertical space required to mount the plate 321 by itself. Furthermore, as the radiator 330 is moved along the guide slot 322, the prominent and depressive parts will provide additional support and stability for the sub-plate 331 and provide a better electrical coupling to the radiator 320.

The radiator 320 includes a first radiation part 321A for processing signals of a first frequency band and a second radiation part 321B, spaced apart from and electrically connected to the first radiation part 321A, for processing signals of a second frequency band lower than the first frequency band. The first radiation part 321A and the second radiation part 321B comprise the plate 321. That is, the first radiation part 321A and the second radiation part 321B are one body, and they can separately process signals of multiple frequency bands.

In the illustrated example, the second radiation part 321B includes the guide slot 322 which allows the sub-radiator 330 to slideably move. In addition, the second radiation part 321B includes the feed part 324 and the ground part 325, each protruding from one end of the second radiation part 321B. By mounting the antenna 300 on a PCB or mother board of a portable wireless terminal, the feed part 324 and the ground part 325 are electrically connected to the PCB of the portable wireless terminal. Here, the feed part 324 provides the first radiation part 321A and the second radiation part 321B with an electrical signal, for example an electrical current. Therefore, the first radiation part 321A and the second radiation part 321B radiate individually.

For example, the first radiation part 321A processes signals of a higher frequency band, and the second radiation part 321B processes signals of a lower frequency band. Herein, the first radiation part 321A and the second radiation part 321B comprise the plate 321, having a radiation pattern. The radiation pattern has a length and a width for radiating various frequencies individually. For example, the radiation pattern length of the first radiation part 321A is distinguishably longer than the radiation pattern length of the second radiation part 321B. Accordingly, signals of a higher frequency band are processed by the first radiation part 321A while signals of a lower frequency band are processed by the second radiation part 321B.

Moreover, because the sub-radiator 330 is electrically connected to the second radiation part 321B and is movable, the antenna 300 can process signals of an additional frequency band, beyond the higher frequency bands processed by the second radiation part 321B without the sub-radiator 330.

The conventional antenna 100 processes signals of dual-frequency bands, such as GSM and DCS. However, by including a sub-radiator 330, an antenna according to an exemplary embodiment of the present invention can individually process signals of triple frequency bands, such as GSM, DCS and PCS, or more without increasing a size of the conventional antenna.

For example, as the sub-radiator 330 is connected electrically to the second radiation part 321B and is selectively movable, the antenna 300 is able to process signals of a high frequency band, such as DCS and PCS, individually and selectively. As illustrated in FIG. 4A, the sub-radiator 330 can move along an imaginary line at the selection of a user, thus allowing the portable terminal to process higher frequency signals that those processed by the second radiation part 321B alone.

FIG. 5 is a partial view of a portable wireless terminal according to an exemplary embodiment of the present invention.

Referring to FIG. 5, an exterior frame 400 includes a third sub-slot 401 through which the position of the sub-radiator 330 may be controlled by a user. In an exemplary implementation, the third sub-slot 401 is provided as an elongated hole through the exterior frame 400. More specifically, as described above, the multi-band built-in antenna 300 is installed in the terminal and the handling protrusion 332 of the sub-radiator 330 is exposed through the third sub-slot 401. The exposed handling protrusion 332, by means of its connection to the guide protrusion 333 movable along the guide slot 322, allows movement of the sub-radiator 330. Accordingly, by movement of the sub-radiator 330 using the handling protrusion 332, a user may select which frequencies are to be targeted for reception. In addition, the handling protrusion 332 may include a suitable prominence to allow easier movement by the user. Furthermore, a surface of the exterior frame 400 may include symbols, figures, lettering or other indicia for indicating a specific frequency band, such as DCS and PCS, targeted for reception.

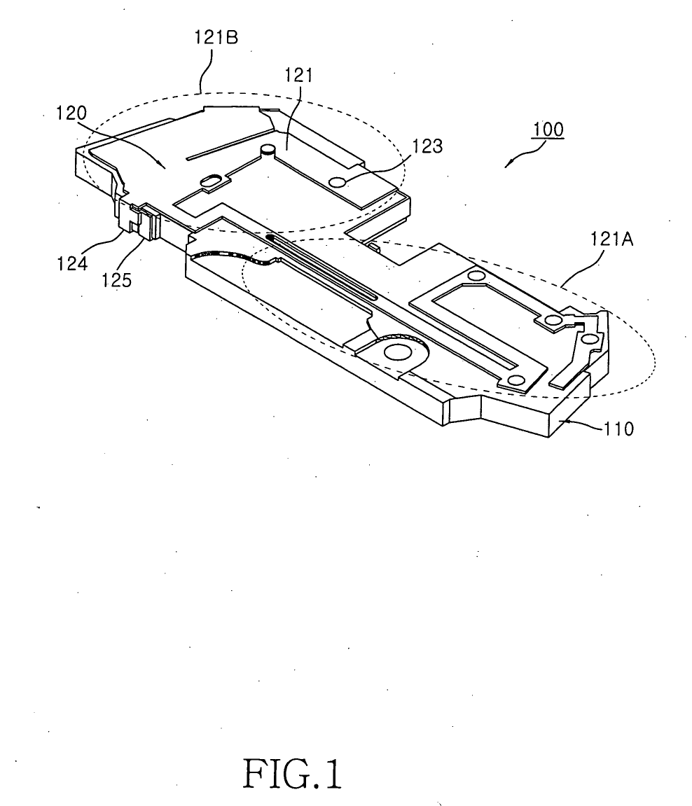

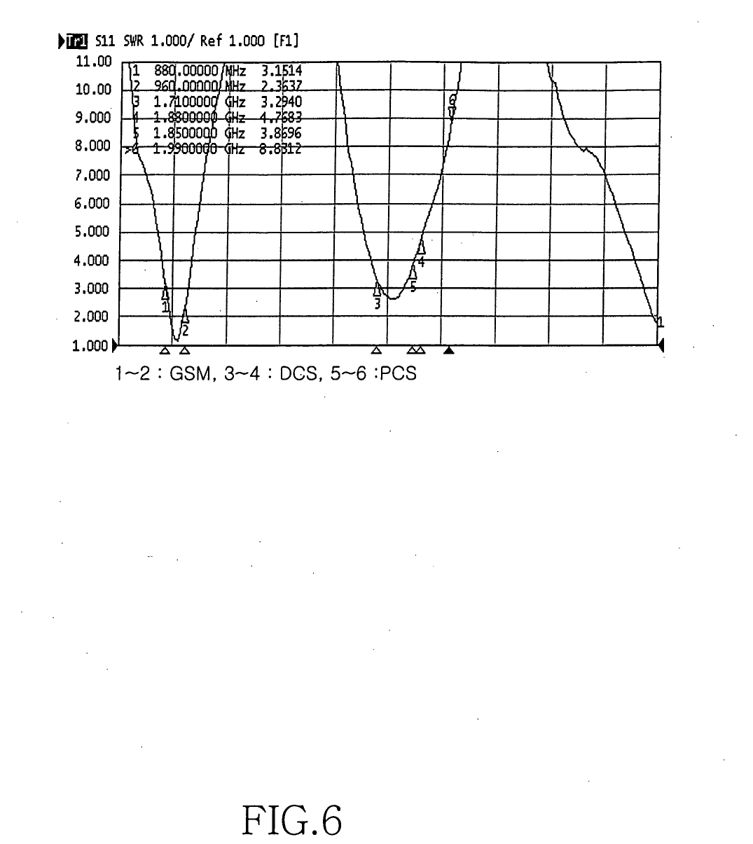

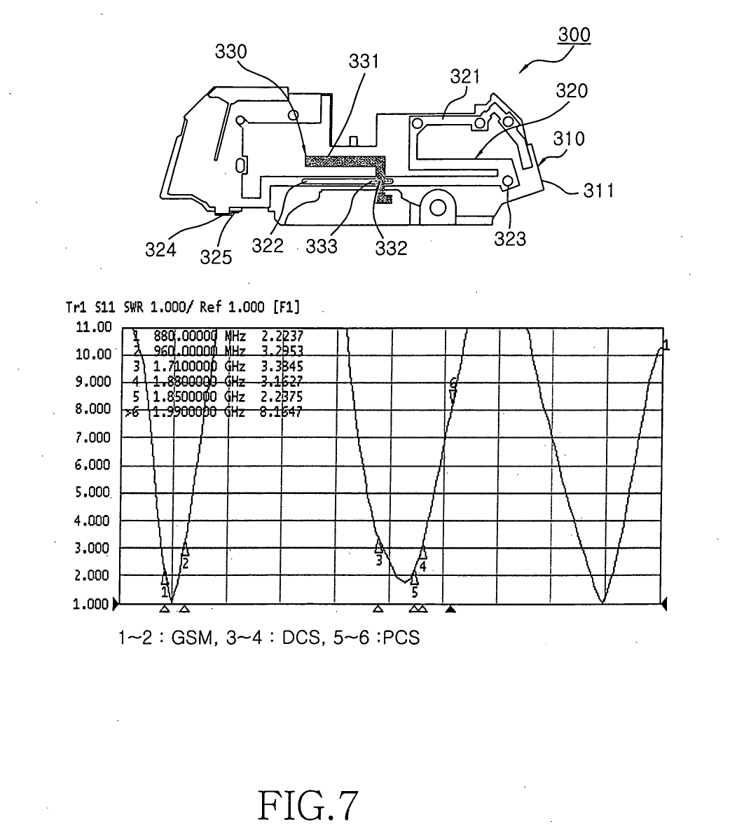

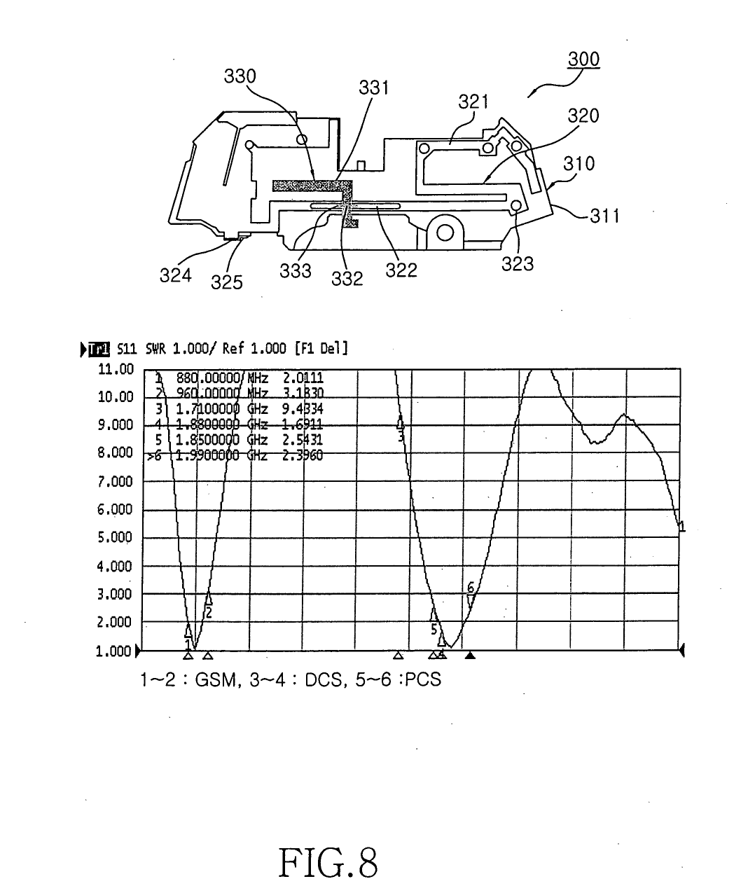

FIG. 6 is a graph illustrating a Voltage Standing Wave Ratio (VSWR) of the conventional dual-band built-in antenna illustrated in FIG. 1. FIG. 7 includes a graph illustrating a VSWR and a partial plane view of the multi-band built-in antenna according to an exemplary embodiment of the present invention, when a sub-radiator is in a position to process signals of a Digital Cellular System (DCS) frequency. FIG. 8 includes a graph illustrating a VSWR and a partial plane view of the multi-band built-in antenna according to an exemplary embodiment of the present invention, when the sub-radiator has moved to process signals of a Personal Communication Systems (PCS) frequency.

Referring to FIGS. 6 to 8, a comparison will be made between the conventional art and exemplary embodiments of the present invention. As illustrated in FIG. 6, the conventional dual-band built-in antenna 100 processes signals of a low frequency band (between points 1 and 2; e.g. GSM) and signals of a high frequency band (between points 3 and 4; e.g. DCS). Namely, the conductive plate 121 is specifically patterned to process signals of the GSM and DCS bands. Therefore, because a Voltage Standing Wave Ratio (VSWR) of PCS (points 5 and 6) is from 3 to 7 and over 8, performance of the conventional dual-band built-in antenna 100 is deteriorated for PCS.

Referring to FIG. 7, the sub-radiator 330 of the multi-band built-in antenna 300 is moved to process signals of a DCS band. As illustrated in FIG. 7, a VSWR of a low frequency band (points 1 and 2; e.g. GSM) indicates that the reception is substantially the same as in the conventional art. However, a VSWR of a high frequency band (points 3 and 4; e.g. DCS) is lower than that of the conventional antenna 100. Therefore, it is evident that performance of the antenna 300 is improved in the DCS band, but performance of the antenna 300 in the PCS band (points 5 and 6) is not improved.

Referring to FIG. 8, the sub-radiator 330 of the multi-band built-in antenna 300 is moved to process signals of a PCS band. As illustrated in the VSWR graph of FIG. 8, performance of the antenna 300 in the GSM band (points 1 and 2) and the DCS band (points 3 and 4) indicates that the reception is substantially the same as in the conventional art regarding these two bands. However, it is evident that performance of the antenna 300 is improved in the PCS band (points 5 and 6).

In conclusion, performance of the antenna 300 in the low frequency band (GSM) is independent of the added radiator 330′ movement. However, to better process signals of high frequency bands (DCS band or PCS band) for the antenna 300, as the sub-radiator 330 is movable, performance of the antenna in a DCS band or a PCS band can improve markedly.

While the invention has been shown and described with reference to certain exemplary embodiments thereof, it will be understood by those skilled in the art that various changes in form and details may be made therein without departing from the spirit and scope of the invention as defined by the appended claims and their equivalents.

What is claimed is:

1. A multi-band built-in antenna for a portable wireless terminal, comprising:
a first radiation part for processing signals of a first frequency band;
a second radiation part spaced apart from the first radiation part and electrically connected to the first radiation part, the second radiation part for processing signals of a second frequency band lower than the first frequency band; and
a sub-radiator electrically connected to the second radiation part, wherein the sub-radiator is movable.

2. The antenna of claim 1, wherein the first radiation part processes signals of a plurality of frequency bands.

3. The antenna of claim 2, wherein the frequency band of signals processed by the first radiation part is changed by moving the sub-radiator to a first position.

4. The antenna of claim 1, further comprising a carrier, wherein the first radiation part and the second radiation part comprise one conductive plate, the single conductive plate being affixed to the carrier.

5. The antenna of claim 1, wherein the sub-radiator comprises a conductive plate.

6. The antenna of claim 4, further comprising a guide protrusion for moving the sub-radiator, wherein the guide protrusion projects downwardly from a lower part of the sub-radiator towards a part of the carrier, and further wherein the second radiation part includes a guide slot for moving the guide protrusion along a path.

7. The antenna of claim 6, wherein the carrier includes a first sub-slot for moving the guide protrusion along the path.

8. The antenna of claim 7, wherein the guide slot comprises an elongated hole formed through the second radiation part and the first sub-slot comprises an elongated hole formed through the carrier.

9. The antenna of claim 8, further comprising a guide block, wherein the guide block has a greater width than the guide protrusion and is fixed to a lower side of the guide protrusion, and wherein the carrier includes a second sub-slot located below the first sub-slot and having a greater width than the first sub-slot, for moving the guide block along a path.

10. The antenna of claim 9, further comprising a handling protrusion, wherein the handling protrusion projects upwardly from a top of the sub-radiator to an exterior of the portable wireless terminal for moving the sub-radiator from the outside, and the exterior of the portable wireless terminal includes a third-sub slot for moving the handling protrusion along a path.

11. The antenna of claim 1, wherein at least one of the first radiation part and the second radiation part include a feed part and a ground part electrically connected to a circuit board of the portable wireless terminal.

12. The antenna of claim 2, wherein the first radiation part is adapted to process signals of at least one of a Digital Cellular System (DCS) and a Personal Communication System (PCS), and the second radiation part is adapted to process signals of a Global System for Mobile communication (GSM).

13. A portable wireless terminal, comprising:
a Radio Frequency (RF) circuit board having a feeding unit and a grounding unit;
a carrier coupled to the RF circuit board;
a first radiation part adapted to process signals of a first frequency band and coupled to a top surface of the carrier;
a second radiation part horizontally spaced from the first radiation part, electrically connected to the first radiation part and coupled to the top surface of the carrier, the second radiation part adapted to process signals of a second frequency band lower than the first frequency band;
a feed part protruding from an end of the first radiation part or the second radiation part and electrically connected to the feeding unit;
a ground part protruding from another end of the first radiation part or the second radiation part and electrically connected to the grounding unit; and
a sub-radiator electrically connected to the second radiation part, wherein the sub-radiator is movable.

14. The portable wireless terminal of claim 13, wherein the first radiation part processes signals of a plurality of frequency spectrums.

15. The portable wireless terminal of claim 13, wherein as the sub-radiator moves, a frequency spectrum in which the first radiation part processes signals is diversified.

16. The portable wireless terminal of claim 13, wherein the first radiation part and the second radiation part comprise one conductive plate.

17. The portable wireless terminal of claim 13, wherein the sub-radiator comprises a conductive plate.

18. The portable wireless terminal of claim 13, further comprising a guide protrusion projecting downwardly from a lower surface of the sub-radiator towards the carrier, wherein the second radiation part includes a guide slot for moving the guide protrusion along a path.

19. The portable wireless terminal of claim 18, wherein the carrier includes a first sub-slot for moving the guide protrusion along the path.

20. The portable wireless terminal of claim 19, wherein the guide slot comprises an elongated hole formed through the second radiation part and the first sub-slot comprises an elongated hole formed through the carrier.

21. The portable wireless terminal of claim 20, further comprising a guide block, wherein the guide block has a greater width than the guide protrusion and is fixed to a lower side of the guide protrusion, and a wherein the carrier includes a second sub-slot located below the first sub-slot and having a greater width than the first sub-slot, for moving the guide block along a path.

22. The portable wireless terminal of claim 21, further comprising a handling protrusion, wherein the handling protrusion projects upwardly from a top of the sub-radiator to an exterior of the portable wireless terminal for moving the sub-radiator from outside, and the exterior of the portable wireless terminal includes a third-sub slot for moving the handling protrusion along a path.

23. The portable wireless terminal of claim 14, wherein the first radiation part processes signals of at least one of a Digital Cellular System (DCS) and a Personal Communication System (PCS), and the second radiation part processes signals of a Global System for Mobile communication (GSM).
